(19) United States
(12) Patent Application Publication
(10) Pub. No.: US 2020/0191193 A1
(43) Pub. Date: Jun. 18, 2020

(54) BEARING DEVICE

(71) Applicant: TYROLON-SCHULNIG GMBH, Hochfilzen (AT)

(72) Inventors: Elmar SCHULNIG, Fieberbrunn (AT); Ludwig SCHULNIG, St. Jakob in Haus (AT)

(73) Assignee: TYROLON-SCHULNIG GMBH, Hochfilzen (AT)

(21) Appl. No.: 16/485,162

(22) PCT Filed: Feb. 2, 2018
(86) PCT No.: PCT/EP2018/052592

§ 371 Date: Aug. 11, 2019

(30) Foreign Application Priority Data
Mar. 9, 2017 (DE) 10 2017 105 016.7

(51) Int. Cl. F16C 11/04; B65G 47/86

(52) U.S. Cl. CPC F16C 11/04; B65G 2201/0244; B65G 47/847

(57) ABSTRACT

A bearing device for at least one gripper arm pair having a first and second gripper arm, the second gripper arm being of mirror-inverted configuration to the first, the at least one gripper arm pair is movable from a gripping position into an open position or vice versa by a rotatably mounted control cam for gripping, holding, and guiding in bottle-like containers. The bearing device has a first bearing pin thr pivotably supporting the at least one first gripper arm, a second bearing pin for pivotably supporting the at least one second gripper arm, a base plate having a seating for pivotably supporting the control cam, and a spacer sleeve for receiving a fixing means for fixing the spacer sleeve on a platform, wherein the bearing pins and the spacer sleeve are fixed to the base plate.

The invention relates to a bearing device for at least one pair of gripper arms which is suited to gripping, holding and guiding in particular bottle-like containers.

To be understood by the term “container” in the context of the present invention is in particular, but not exclusively, containers having a substantially circular cross section, e.g. bottles, cans or glassware, consisting of glass, metal or plastic according to the respective requirement.

A gripper arm pair as such in particular, but not exclusively, comprises a first gripper arm and a second gripper arm which grip a container by way of a pincer motion and which can hold, transport and guide the container via positive or frictional connection of the container between the two gripper arms. The second gripper arm is thereby in particular configured mirror-inverted to the first gripper arm. During the pincer motion, the gripper arm pair moves from an open position into a gripping position, whereby in the open position, a container can be positioned between the spread gripper arms, and in the gripping position, the gripper arms either grasp and hold a container or, without a container arranged between said gripper arms, are closed and can in particular touch each other.

The use of such gripper arm pairs, also called clamp grippers, is known in the beverage industry. It is customary in that context, at least on an industrial scale, for containers, in particular bottles, to be filled with liquids, such as for example water, juice, beer, etc., and sealed in production lines/bottling plants or container filling and transport systems. A production line usually comprises a cleaning system for the containers, a filling station for filling the liquid into the containers, and a sealing system for sealing the containers. The different systems are connected together by means of feeder systems which can be configured as assembly lines, transport stars, etc.

A transport star, also referred to as a damping star, is a device which is able to rotate around an axis and has a plurality of clamp grippers at the edge of an in particular circular support plate. The support plate is rotatable about the axis, whereby the clamp grippers grab and release a container on container transport flows running in particular tangentially to the support plate and transport the container along a circular arc between these points.

Although gripper arm pairs are suited to grasping containers of different sizes, in particular diameters, due to the pincer motion, there are however tolerance limits contingent upon the length and gripping configuration of the gripper arms and the maximum opening angle between the gripper arms. If these limits are exceeded, containers which are too small or too large, in particular of a different shape, can no longer be stably gripped and held. Therefore, when adapting a production line to a new type of container, it may become necessary to replace the gripper arm pairs with ones able to hold the new containers without any difficulty.

The gripper arms are likewise subject to attrition/wear and thus a statistical lifespan stemming from the mechanical load occurring during the movement from the open position into the gripping position and vice versa as well as the holding of the containers. Once the gripper arms are worn out to the extent they can no longer perform their gripping function, they need to be replaced. This is the case when, for example, gripper arms made of metal have been bent through wear or gripper arms made of plastic have at least partially broken off.

In the above-cited situations, in which the gripper arms need to be replaced, the systems are stopped and the respective gripper arms manually changed. These planned or unplanned operational interruptions negatively impact the revenue of the company operating such systems equipped with transport stars or similar systems equipped with gripper arms and should therefore be kept as short as possible.

A bearing unit on which a gripper arm pair is arranged and supported is known from printed publication DE 10 2014 111 564. The bearing unit allows an operator or establishment to replace a gripper arm pair relatively quickly compared to other prior art.

The prior art does, however, have further numerous disadvantages. For instance, the above-cited bearing unit is for example of relatively large dimensions and not particularly easily mountable on a transport star. Moreover, the bearing unit consists of a plurality of individual separate components which complicates handling when replacing a gripper arm pair.

It is thus the task of the present invention to design a bearing device which eliminates or at least minimizes the known prior art disadvantages.

This task is inventively solved by a bearing device in accordance with claim 1. Accordingly, a bearing device for at least one pair of gripper arms having a first gripper arm and a second gripper arm of mirror-inverted configuration thereto is provided, wherein the at least one gripper arm pair is movable from a gripping position into an open position or vice versa by means of a rotatably mounted control cam for gripping, holding and guiding in particular bottle-like containers. The bearing device additionally comprises a first bearing pin for pivotably supporting the at least one first gripper arm, a second bearing pin for pivotably supporting the at least one second gripper arm, a base plate with a seating for pivotably supporting the control cam, and a spacer sleeve for receiving a fixing means for fixing the spacer sleeve on a platform, wherein the bearing pins and the spacer sleeve are fixed to the base plate.

This bearing device or respectively bearing structure has the advantage of all the components being firmly connected together and thus providing a compact device which does not require time-consuming assembling and can be more quickly and easily mounted to a platform.

Additionally, the base plate forms a boundary for the bearing pin such that the inserted gripping arms cannot slide out of or slip under the bearing pin. Moreover, due to the base plate, the bearing pin can be extended and thus accommodate multiple gripper arm pairs without any tilting or deforming of the bearing pin during the pincer motion. That is particularly because one end of the bearing pin is inserted into a carrier platform in the mounted state and the other end into the base plate and thus no leverage can act over the entire length of the pin but rather only one end of the pin.

A further advantage is based on the spacer sleeve which, as the sole component of the bearing device, substantially defines and maintains the distance to the platform, in particular between the base plate and platform, Thus, no laborious adapting of different bearing device components is necessary to define the height or respectively distance. Furthermore, only one single fixing means is required, same fixing the spacer sleeve and thereby the bearing device to the platform. The replacing of the at least one gripper arm pair and the mounting of the bearing device on the platform are thus simplified.

The following describes preferential embodiments of the invention as specified in the subclaims.

The bearing pins are advantageously removably inserted into the platform and the spacer sleeve arrangeable on the platform and releasably attached to the platform by the fixing means. The removable insertability as well as releasable attachability allow fast and uncomplicated replacement of the bearing device. The spacer sleeve is thereby in particular configured such that it cannot tilt on the surface of the platform. This is for example possible by the end of the sleeve facing the platform, in particular its wall thickness, being configured complementary to the mounting position of the spacer sleeve on the platform or when the end of the sleeve and the platform are level. Due to their insertability, in particular on/in the platform in the inserted state, the bearing pins essentially prevent a pivoting of the bearing device about the spacer sleeve axis.

In a further advantageous embodiment, the length of the spacer sleeve is shorter than the length of the bearing pin. This is particularly advantageous with a flat platform surface since the ends of the bearing pins are thereby always inserted into corresponding seatings of the platform as soon as the spacer sleeve is arranged at its mounting position on the platform and the bearing device aligned so as to be ready for operation or securing. The bearing pins thus also form a type of guide means when arranging the bearing device on the platform.

The base plate preferably exhibits at least four drill holes for receiving the first and second bearing pin, the spacer sleeve and the control cam. This advantageous configuration of the base plate enables simple production and uncomplicated assembly of the bearing device, whereby the corresponding components can be arranged in the base plate and affixed for example by welding or force fit. The drill hole for the control cam is configured such that the control cam can be easily inserted and has enough play in the inserted state so as to be able to rotate or pivot respectively.

Likewise having proven advantageous is for the spacer sleeve to be arranged with the base plate or configured such that the fixing means is insertable from one end of the spacer sleeve and can partially lead out from the other end of the spacer sleeve. The securing of the bearing device is thus further simplified. Additionally, the sleeve can simply be configured such, that it serves as a guide means for the fixing means. As soon as the fixing means is led through the sleeve, inserted into the platform and affixed, and the sleeve pressed against the platform, the sleeve, particularly its end, forms a frictional connection with the surface of the platform.

In a further advantageous embodiment, the bearing device exhibits a bearing plate as a platform comprising a first and a second seating for the inserting of the first and second bearing pin, a third seating on which the spacer sleeve can be arranged and in which the fixing means is releasably securable, as well as a fourth seating for pivotably supporting the control cam. As soon as at least the gripper arms of the at least one pair of gripper arms are arranged on the bearing pins, the base plate with the bearing pin can be set on the bearing plate and attached together with fixing means via the spacer sleeve. Additionally, the control cam can also be inserted before or after the assembling of the base plate and bearing plate. Each bearing device thereby has its own separate bearing plate. Lastly, the operator of a transport star immediately has a unit at his disposal in which all the necessary components of a clamp gripper can be installed and then be substantially operationally ready. This thereby circumvents a laborious selecting and assembling of the components of a clamp gripper, in particular the gripper arms and the bearing device, and the inserting and mounting of the bearing device, in particular its base plate, bearing pin and spacer sleeve, on the platform.

Preferably, the bearing plate is adapted so as to be fixed, in particular detachably, to a support plate of a clamping star. At least three seatings are required when mounting the bearing device of base plate, bearing pin and spacer sleeve (without bearing plate); or four seatings if an additional seating serves as to support the control cam. The bearing plate can be secured on the support plate with only one or with multiple fixing means, whereby the mounting of the bearing device on the support plate is simplified and the production of the support plate inherently becomes more economical due to a fewer number of drill holes.

Advantageously, a fixing means guided through the spacer sleeve is configured as a screw which is releasably securable to or in the platform. The screw can be screwed into a threaded seating of the platform and in particular dimensioned so as to pass through the spacer sleeve and concurrently, in the screwed-in state, prevent a displacing of the sleeve perpendicular to the screw. The screw head thereby exerts a force on the one end of the sleeve, whereby a frictional connection additionally occurs between the other end of the sleeve and the platform. A screw as fixing means is easy and economical to produce and can be readily inserted and disengaged if necessary.

Further preferential embodiments are provided which can exhibit the features described in the following, in particular in conjunction with the features of one or more subclaims.

The bearing pins and the spacer sleeve are preferably arranged parallel to each other and perpendicular to the base plate and exhibit a consistent diameter over their entire length. On the other hand, the diameter of the bearing pins can be adapted to the corresponding bearing drill holes of a gripper arm in a longitudinal section of said bearing pin. Additionally, the end sections can exhibit a diameter or a shape and/or an offset to the axis of the bearing pin which is adapted to the drill hole of the base plate and/or the seating of the platform. That means that the bearing pin can be configured with differing longitudinal sections of different diameter, shape and/or axes.

The base plate can be of trapezoidal, rhombus, deltoid, rectangular or elliptical configuration and exhibit a thickness between 3 and 10 mm, preferably 5 mm. These shapes are easy to produce and the bearing plate can be the same shape as the base plate.

The individual components of the bearing device can consist either of metal or plastic depending on individual mechanical load requirements and material and manufacturing costs.

The following will reference the accompanying schematic drawings in describing the invention in greater detail on the basis of exemplary embodiments incorporating further details.

Shown are:

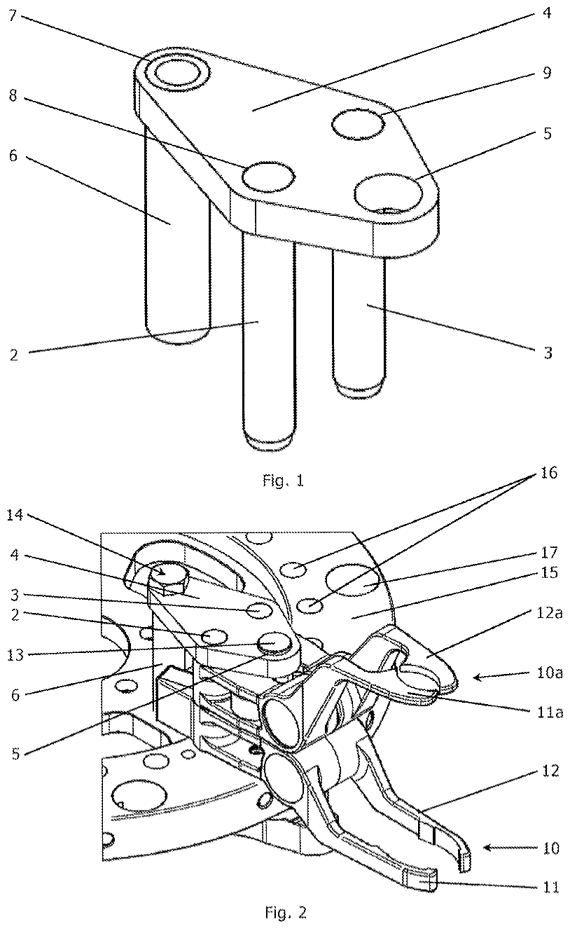

FIG. 1 a perspective view of a bearing device according to the present invention;

FIG. 2 a perspective view of a bearing device from FIG. 1 which supports two. gripper arm pairs and is affixed to a support plate of a transport star;

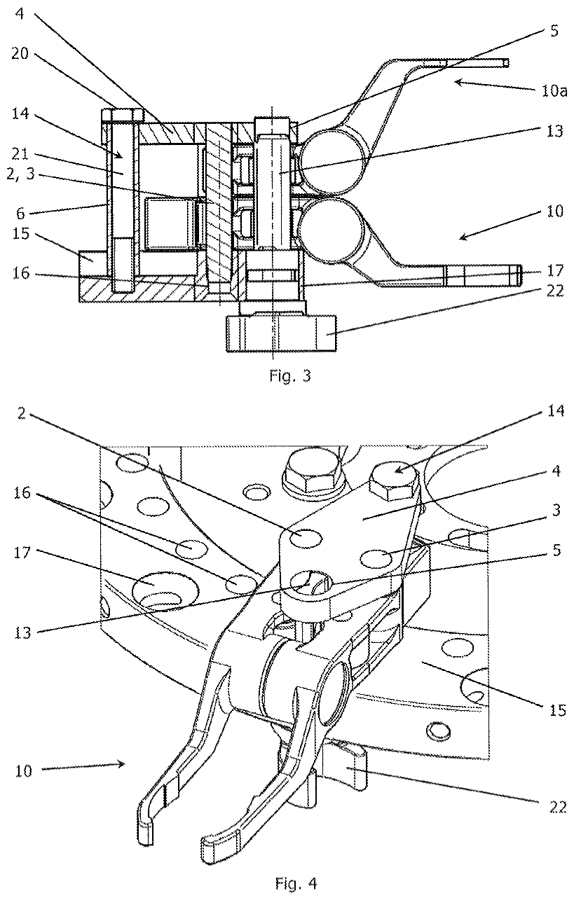

FIG. 3 a cross section of the bearing device from FIG. 2;

FIG. 4 a perspective view of a bearing device from FIG. 1 which supports one gripper arm pair and is affixed to a support plate of a transport star;

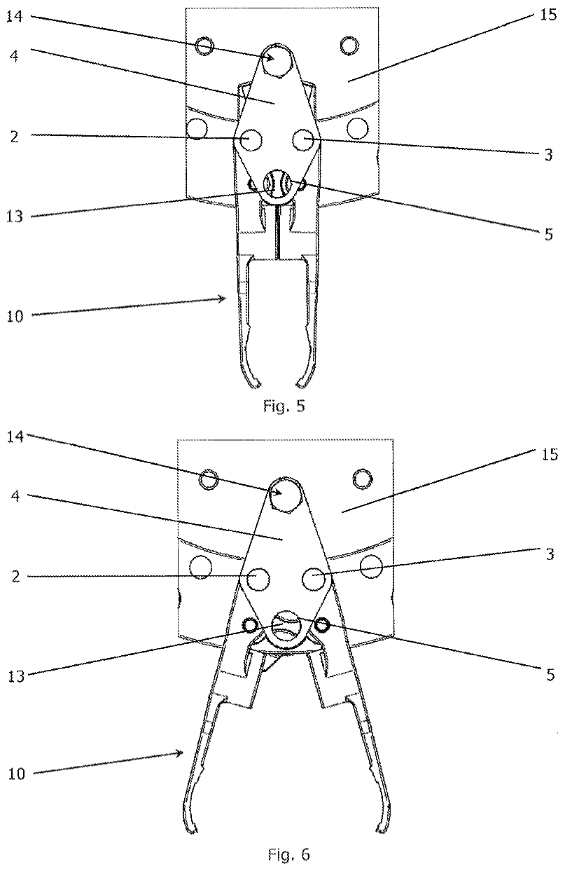

FIG. 5 a view from above of the bearing device from FIG. 4 in the gripping position; and

FIG. 6 a view from above of the bearing device from FIG. 4 in the open position.

The bearing device depicted in FIG. 1 is essentially formed by a base plate 4, a first and second bearing pin 2, 3 and a spacer sleeve 6. The spacer sleeve 4 and the bearing pins 2, 3 are inserted into correspondingly configured drill holes 7, 8, 9 on the base plate 4 and fixed by laser welding. The ends of the spacer sleeve 4 and the bearing pins 2, 3 are even and arranged flush or aligned with the surface of the base plate 4. The other end of the spacer sleeve 4 is likewise flush. The other ends of the bearing pins 2, 3 are also flush albeit with chamfered edge; i.e. a chamfer is provided at the edge of the pin in order to facilitate the inserting of the bearing pins 2, 3 into corresponding seatings of a platform. Additionally, a drill hole 5 is configured in the kite or deltoid shaped base plate 4 diagonally from drill hole 7 as a seating and support for a control cam. Imagined connecting lines run perpendicular between the center points of the drill hole 7 for the spacer sleeve 4 and the drill hole 5 for the control cam as well as between the center points of drill holes 8 and 9 for the bearing pins 2 and 3. The deltoid-shaped base plate 4 is rounded at its corners in order to enable user-friendly handling of the bearing device. The spacing of the bearing pin drill holes 8, 9 depends primarily on the platform which will be used and the associated bearing pin seatings of the platform into which the bearing pins are inserted.

In FIG. 2, the bearing device from FIG. 1 is equipped with two gripper arm pairs 10 and 10a and a control cam 13 and fixed on a support plate 15 as a platform by fixing means 14 in the form of a screw. The support plate 15 comprises a plurality of bearing pin seatings 16, control cam seatings 17 and threaded seatings (not visible) for the screws 14 which are configured concentrically around an axial center (not visible) of the support plate 15 at the edge of the support plate 15. Screw 14 is arranged in the spacer sleeve 6 of the bearing device and screwed into the corresponding seating of the support plate. Due to the screw head of screw 14, the spacer sleeve 6 is pressed onto the surface of the support plate. The control cam 13 is fixed rotatably mounted in the control cam seating 17 and arranged between the first gripper arms 11, 11a and the second gripper arms 12, 12a. Since the gripper arms 11, 11a, 12, 12a are opera-tively connected to the control cam 13, not inconsiderable leverage is exerted on the control cam 13. In order to minimize such mechanical load of the control cam 13 in the region of the control cam seating 17, the upper end of the control cam 13 is arranged rotatably mounted in a drill hole 5 of the base plate 4. By means of the screw 14, which extends through the base plate 4 and the spacer sleeve 6, the entire bearing device is thus held firmly on the support plate 15. The first gripper arms 11 and 11a of the first and second gripper arm pair 10 and 10a are arranged rotatably mounted on the first bearing pin 2 of the bearing device and the second gripper arms 12 and 12a of the first and second gripper arm pair 10 and 10a on the second bearing pin 3 of the bearing device. The gripper arm pairs 10 and 10a are in the gripping or closed position since the control cam 13, as opening means, is not spreading the first and the second gripper arms 11, 11a, 12, 12a of the gripper arm pairs 10, 10a in the position depicted and the first and second gripper arms 11, 11a, 12, 12a are automatically drawn to each other by attracting magnets arranged within the gripper arms as a closure means (not visible). It is noted at this point that in another embodiment, the drill hole 5 for the control cam can also be configured between the bearing pin drill holes 8 and 9 and the spacer sleeve drill hole 7, The control cam seating 17 would be repositioned on the support plate 15 accordingly. The control cam can thereby be arranged behind the axes of the bearing pins 2, 3 and rotatably mounted and serve as closure means for the gripper arm pairs 10, 10a.

The cross-sectional view in FIG. 3 depicts the bearing device from FIG. 2 fixed to the support plate 15, the control cam 13, the two gripper arm pairs 10, 10a and the screw 14. The sectional line does not run completely diagonally in the base plate 4, or on the line between the center points of the control cam drill hole 5 and the spacer sleeve 6 respectively, but rather also runs offset by a bearing pin 2 or 3. The screw 14 is formed by a screw head 20 and an adjoining screw thread 21. At its bottom, the control cam 13 comprises an actuating/catch claw 22 which can be rotated by the control cam and the gripper arm pairs 10, 10a thus opened. Additionally visible are the different seatings 16 and 17 in the form of drill holes in the support plate 15 for the bearing pins 2, 3 and the control cam 13. The axes of the spacer sleeve 6 (and thus screw 14), the bearing pin 2, 3 and the control cam 13 run parallel to each other.

FIG. 4 depicts a similar embodiment of the bearing device to that of FIG. 2. The only difference is that the bearing device only supports one gripper arm pair 10 and accordingly has at least one shorter spacer sleeve (not visible). The bearing pins 2, 3 can also be shortened accordingly.

FIGS. 5 and 6 both show a top plan view of the bearing device from FIG. 4, once in the gripping position and once in the open position. Thereby particularly visible is the interaction of the control cam 13 with a gripper arm pair 10.

### LIST OF REFERENCE NUMERALS

2 first bearing pin
3 second bearing pin
4 base plate
5 seating/drill hole
6 spacer sleeve
7 drill hole (for spacer sleeve)
8 drill hole (for first bearing pin)
9 drill hole (for second bearing pin)
10 gripper arm pair
10a second gripper arm pair
11 first gripper arm
11a first gripper arm (of second pair)
12 second gripper arm
12a second gripper arm (of second pair)
13 control cam
14 fixing means
15 support plate (as platform)
16 bearing pin seating
17 control cam seating
20 screw head
21 screw thread
22 actuating/catch claw

1. A bearing device for at least one gripper arm pair having a first and a second gripper arm, the second gripper arm being of mirror-inverted configuration to the first, wherein the at least one gripper arm pair is movable from a gripping position into an open position or vice versa by means of a rotatably mounted control cam for gripping, holding and guiding in particular bottle-like containers,
wherein
a first bearing pin for pivotably supporting the at least one first gripper arm,
a second bearing pin for pivotably supporting the at least one second gripper arm,
a base plate having a seating for pivotably supporting the control cam, and by
a spacer sleeve for receiving a fixing means for fixing the spacer sleeve on a platform, wherein the bearing pins and the spacer sleeve are fixed to the base plate.

2. The bearing device of claim 1,
wherein
the bearing pins are removably inserted into the platform and the spacer sleeve is arrangeable on the platform and releasably attached to the platform by the fixing means.

3. The bearing device of claim 1,
wherein
the length of the spacer sleeve is shorter than the length of the bearing pin.

4. The bearing device of claim 1,
wherein
the base plate exhibits at least four drill holes for receiving the first and second bearing pin, the spacer sleeve and the control cam.

5. The bearing device of claim 1,
wherein the spacer sleeve is arranged with the base plate or configured such that the fixing means is insertable from one end of the spacer sleeve and can partially lead out from the other end of the spacer sleeve.

6. The bearing device of claim 1,
wherein
a bearing plate as a platform comprising a first and a second seating for the inserting of the first and second bearing pin, a third seating on which the spacer sleeve can be arranged and in which the fixing means is releasably securable, as well as a fourth sealing for pivotably supporting the control cam.

7. The bearing device of claim 6,
wherein
the bearing plate is adapted so as to be fixed to a support plate of a clamping star.

8. The bearing device of claim 1,
wherein
a fixing means guided through the spacer sleeve configured as a screw releasably securable to the platform.
